(19) United States
(12) Patent Application Publication
(10) Pub. No.: US 2017/0255792 A1
(43) Pub. Date: Sep. 7, 2017

(54) METHOD AND APPARATUS FOR PROTECTING PRIVACY IN CONSIDERATION OF APPLICATION USAGE PATTERN

(71) Applicant: ELECTRONICS AND TELECOMMUNICATIONS RESEARCH INSTITUTE, Daejeon (KR)

(72) Inventors: Seung-Hyun KIM, Daejeon (KR); Seok-Hyun KIM, Daejeon (KR); Soo-Hyung KIM, Daejeon (KR); Jong-Hyouk NOH, Daejeon (KR); Sang-Rae CHO, Daejeon (KR); Young-Seob CHO, Daejeon (KR); Jin-Man CHO, Daejeon (KR); Seung-Hun JIN, Daejeon (KR); Jung-Yeon HWANG, Daejeon (KR)

(21) Appl. No.: 15/430,236

(22) Filed: Feb. 10, 2017

(30) Foreign Application Priority Data
Mar. 2, 2016 (KR) 10-2016-0024978

(51) Int. Cl. G06F 21/62; G06F 21/60

(52) U.S. Cl. CPC G06F 21/6245; G06F 21/604

(57) ABSTRACT

Disclosed herein are an apparatus and method for protecting privacy in which, in consideration of an application usage pattern, personal information is selectively provided depending on the purpose of use of the service of an application and on the privacy level, whereby a user may make better use of the service and the user's privacy may be effectively protected.

### CROSS REFERENCE TO RELATED APPLICATION

This application claims the benefit of Korean Patent Application No. 10-2016-0024978, filed Mar. 2, 2016, which is hereby incorporated by reference in its entirety into this application.

### BACKGROUND OF THE INVENTION

1. Technical Field

The present invention relates generally to a method and apparatus for protecting privacy and, more particularly, to a method and apparatus for protecting privacy in which a level based on which personal information of a user is differently provided is controlled in consideration of an application usage pattern in a mobile environment or the like.

2. Description of the Related Art

In a mobile environment, users may freely install various applications on their mobile terminals and use the applications. These applications may provide users with customized services using personal information or status information stored in their mobile terminals. However, because anybody can develop a desired application, an application developed with malicious purposes in mind may be used to obtain personal information of a user for the illegal use thereof. Generally, users do not thoroughly check the permissions that are granted to applications, and applications that have been granted permissions only a single time may freely access personal information without the involvement of users.

Users have no idea how applications internally operate in a mobile terminal. That is, users do not know when or why an application accesses and uses personal information or status information stored in their mobile terminals. Currently, Google's Android and Apple's iOS, which are the two representative platforms for providing a mobile environment, do not solve this problem. In the case of Google's Android, if a user grants access to personal information a single time when installing an application, it is impossible to monitor and control the use of personal information after the application is installed. In the case of Apple's iOS, when an application first accesses personal information, the user's approval is requested, and whether to approve access to personal information may be changed in a settings screen, but it is impossible to monitor access to personal information once such access has been approved. In order to solve these problems, existing patents or privacy management tools provide some functions for controlling personal information, but these functions merely enable changing whether to permit each application to access personal information or recording the history of such access.

For example, Korean Patent Application Publication No. 10-2012-0135708, disclosed on Dec. 17, 2012 and titled “Method for evaluating abuse rating and protecting smart phone private information”, proposed a method in which a server retains a list of malicious applications and a terminal determines whether an application is malicious using the list received in response to a request by the terminal. However, this method is problematic in that a malicious application that is not present in the list may not be detected, and in that the operation of an application cannot be checked in real time.

Also, in Korean Patent No. 10-1291123, disclosed on Aug. 1, 2013 and titled “Method and apparatus for controlling management of application in portable device and recordable medium in which program for performing the method is recorded”, the operation of an application is controlled based on a preset application management policy. However, it is difficult in practice to specify management policies for all applications.

Also, Korean Patent Application Publication No. 10-2013-0085722, disclosed on Jul. 30, 2013 and titled “Security solution system for privacy protection in mobile phone”, provides a system for checking the permissions allowed for a running application and the amount of resources consumed by the application and for informing a user of abnormal cases. However, this system is less relevant to the detection of privacy violations committed by applications.

Also, Korean Patent Application Publication No. 10-2014-0113389, disclosed on Sep. 24, 2014 and titled “Computing system with privacy mechanism and method of operation thereof”, provides a computing system in which privacy preferences customized to a user are predicted from previous settings made in relation to the sharing of personal information. However, because the privacy preference is applied to respective applications, it is difficult to more precisely manage privacy compared to when the privacy preference is recommended based on an application usage pattern. Also, the computing system is problematic in that privacy protection through the processing of personal information is not provided.

### SUMMARY OF THE INVENTION

Accordingly, the present invention has been made keeping in mind the above problems, and an object of the present invention is to provide a method and apparatus for protecting privacy in which, in consideration of an application usage pattern, personal information is selectively provided depending on the purpose of use of an application service and the privacy level of the service, whereby a user may make better use of the service and the user's privacy may be effectively protected.

The technical objects of the present invention are not limited to the above-mentioned object, and other technical objects that have not been mentioned will be clearly understood from the following description by those skilled in the art.

First, in order to accomplish the above object, an apparatus for protecting privacy for controlling a level related to provision of personal information in response to a request for personal information in an application service provided in a user terminal according to an embodiment of the present invention includes an app modification unit for creating a modified app by modifying an original app in order to identify a flow of execution of a class for a service and to control processing of personal information; and a personal information processing unit for updating a user's app usage pattern according to a class call signal received from the modified app, applying a privacy level to respective nodes for a class and a personal information access API, which are executed in the modified app, according to a personal information call signal received from the modified app, and providing the corresponding personal information to the modified app.

The app modification unit may include an app modification module for modifying the original app in such a way that a tag is added in a function executed in each class so as to generate the class call signal when the corresponding class is executed in order to identify the flow of execution of the class, and in such a way that the personal information access API of each class is modified so as to generate the personal information call signal when the personal information is accessed.

The personal information processing unit may include an app pattern-recording module for updating the user's app usage pattern in which the class executed in the modified app, the personal information access API called therein, and the corresponding personal information are classified for each service according to the class call signal.

The app pattern-recording module may set the executed class and a call of the personal information access API as nodes, set a sequence in which classes are executed as an edge, and thereby provide the user's app usage pattern for each service in a graphical form on a screen of the user terminal.

The personal information processing unit may include a privacy level determination module for determining a privacy level using information directly received from a user at a corresponding time, information about a preset privacy policy, and information recommended in a system in order to apply the privacy level to each of the nodes.

Also, a method for protecting privacy for controlling a level related to provision of personal information in response to a request for personal information in an application service provided in a user terminal according to another embodiment of the present invention includes creating a modified app by modifying an original app in order to identify a flow of execution of a class for a service and to control processing of personal information; and updating a user's app usage pattern according to a class call signal received from the modified app, applying a privacy level to respective nodes for a class and a personal information access API, which are executed in the modified app, according to a personal information call signal received from the modified app, and providing the corresponding personal information to the modified app.

Creating the modified app may include modifying the original app in such a way that a tag is added in a function executed in each class so as to generate the class call signal when the corresponding class is executed in order to identify the flow of execution of the class, and in such a way that the personal information access API of each class is modified so as to generate the personal information call signal when the personal information is accessed.

The user's app usage pattern may be updated such that the class executed in the modified app, the personal information access API called therein, and the corresponding personal information are classified for each service.

The method for protecting privacy may further include setting the executed class and a call of the personal information access API as nodes, setting a sequence in which classes are executed as an edge, and thereby providing the user's app usage pattern for each service in a graphical form on a screen of the user terminal.

Providing the corresponding personal information to the modified app may be configured such that the privacy level is applied to each of the nodes by determining the privacy level using information directly received from a user at a corresponding time, information about a preset privacy policy, and information recommended in a system.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a privacy-protecting apparatus according to an embodiment of the present invention;

FIG. 2 is a flowchart for describing the operation of an application modification service of a privacy-protecting apparatus according to an embodiment of the present invention;

FIG. 3 is a flowchart for describing the operation for monitoring the execution of an application and providing personal information in a privacy-protecting apparatus according to an embodiment of the present invention;

FIG. 4 is a view that shows an example of calling a class and a personal information access API in a privacy-protecting apparatus according to an embodiment of the present invention;

FIG. 5 is a view that shows an example in which a privacy level is input by a user in a privacy-protecting apparatus according to an embodiment of the present invention; and

FIG. 6 is a view for describing an example of a method for implementing a privacy-protecting apparatus according to an embodiment of the present invention.

### DESCRIPTION OF THE PREFERRED EMBODIMENTS

Hereinafter, embodiments of the present invention will be described in detail with reference to the accompanying drawings. It should be noted that the same reference numerals are used to designate the same or similar elements throughout the drawings. In the following description of the present invention, detailed descriptions of known functions and configurations which are deemed to make the gist of the present invention obscure will be omitted.

Various terms, such as “first”, “second”, “A”, “B”, “(a)”, “(b)”, etc., can be used to differentiate one component from the other, but the substances, order or sequence of the components are not limited by the terms. Unless differently defined, all terms used here, including technical or scientific terms, have the same meanings as the terms generally understood by those skilled in the art to which the present invention pertains. Terms identical to those defined in generally used dictionaries should be interpreted as having meanings identical to contextual meanings of the related art, and are not to be interpreted as having ideal or excessively formal meanings unless they are definitely defined in the present specification.

Combinations of blocks or steps in the block diagrams or flowcharts illustrated in the accompanying drawings may be implemented through computer program instructions. Because these computer program instructions may be loaded into the processor of a general-purpose computer, a special-purpose computer or a programmable data-processing apparatus, the instructions executed by the processor of the computer or programmable data-processing apparatus create a means for performing the functions specified in each block or step in the block diagrams or flowcharts in the drawings. In order to implement the functions in a specific manner, these computer program instructions may also be stored in computer-usable or computer-readable memory that may direct a computer or a programmable data-processing apparatus. Accordingly, the instructions stored in the computer-usable or computer-readable memory may produce a manufactured item that includes a means for executing instructions for performing the functions specified in each block or step in the block diagrams or flowcharts in the drawings. Also, these computer program instructions may be loaded in a computer or a programmable data-processing device. In this case, a process executable by a computer is created by performing a series of operations in the computer or the programmable data-processing device, whereby the instructions that operate the computer or the programmable data-processing apparatus may provide steps for performing the functions specified in each block or step in the block diagrams or flowcharts in the drawings.

Also, each block or step in the drawings may indicate a module, a segment, or a part of code that includes one or more executable instructions for performing a logical function (or functions) specified therein. Also, in some alternative embodiments, the functions specified in blocks or steps may be performed in a different order. For example, two consecutively illustrated blocks or steps may be performed at the same time, or occasionally, they may be performed in the reverse order depending on the corresponding function.

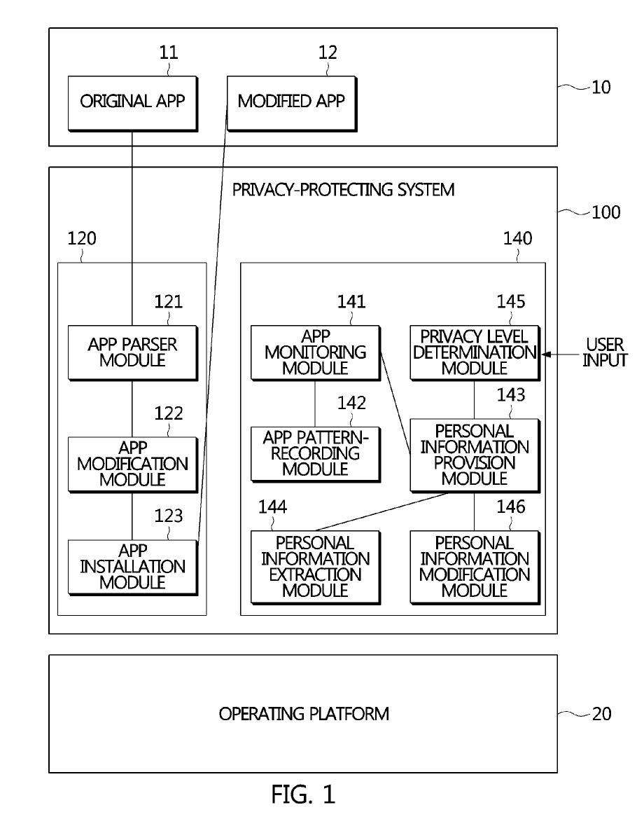

FIG. 1 is a view illustrating a privacy-protecting apparatus 100 according to an embodiment of the present invention. Hereinafter, the term “application” is abbreviated to “app.”.

Referring to FIG. 1, the privacy-protecting apparatus 100 according to an embodiment of the present invention includes an app modification unit 120 and a personal information processing unit 140. The privacy-protecting apparatus 100 operates in conjunction with an operating platform 20 and a storage unit 10 for storing an original app 11 and a modified app 12 therein. The app modification unit 120 includes an app parser module 121, an app modification module 122, and an app installation module 123. Also, the personal information processing unit 140 includes an app-monitoring module 141, an app pattern-recording module 142, a personal information provision module 143, a personal information extraction module 144, a privacy level determination module 145, and a personal information modification module 146.

The storage unit 10, the operating platform 20 and the privacy-protecting apparatus 100 are installed in a user terminal, and they operate so as to enable personal information to be selectively provided depending on the purpose of use of an application service and the privacy level of the service in consideration of an application usage pattern, whereby a user may make better use of the service and privacy may be protected.

Desirably, a user terminal described in the present invention may be a mobile terminal, such as a smart phone, a wearable device through which a voice or video call may be made, a tablet PC, a laptop computer or the like. However, without limitation to the examples, it may include a wired terminal, such as a desktop PC, other communication devices or the like. Depending on the communication environment, such a user terminal may support wireless Internet communication such as Wi-Fi, WiBro and the like, mobile communication such as WCDMA, LTE and the like, Wireless Access in Vehicular Environment (WAVE) mobile communication, wired Internet communication, and the like.

In FIG. 1, the original app 11 may be a program or service running on a user terminal. Here, without limitation as to the function or the form, the original app 11 may have various functions and forms for providing a service according to various purposes, for example, a bank account service app provided by financial companies, a credit payment app, a shopping app, a chauffeur service app and the like. The modified app 12 is an app configured such that some functions of the original app 11 are modified and stored by the app modification unit 120 for the purpose of protecting privacy.

The operating platform 20 handles the overall management and operation of the user terminal. The operating platform 20 may be an Operating System (OS), and functions to manage a program, data and the like stored in a storage means, which are required for the overall management and operation of a user terminal, to control the execution of a program for the operation of the user terminal and the display of the program on a screen, and the like, and to manage personal information according to the present invention in the storage means. It is desirable for the operating platform 20 to be installed and operated in the user terminal, but according to the circumstances, it may be operated as an external device of the user terminal.

The app modification unit 120 of the privacy-protecting apparatus 100 includes the app parser module 121, the app modification module 122, and the app installation module 123 in order to create a modified app 12 from the original app 11.

The app parser module 121 parses and analyzes the file of the original app 11, and thereby makes a file in an editable format therefrom. The app modification module 122 modifies the file in an editable format, which is acquired from the original app 11, such that the flow of execution of each class for providing a service may be identified, and such that processing of a request for or access to personal information, managed in the operating platform 20, may be controlled. The app installation module 123 converts the modified file of the original app 11 to an installable format, and then stores and installs the corresponding modified app 12 in the storage unit 10.

The personal information processing unit 140 of the privacy-protecting apparatus 100 includes the app-monitoring module 141, the app pattern-recording module 142, the personal information provision module 143, the personal information extraction module 144, the privacy level determination module 145, and the personal information modification module 146 in order to monitor the flow of execution of each class in the modified app (file) 12 and to process access to personal information in response to a request therefore when an application service is provided through the modified app 12.

If a service is provided by running the modified app 12, the modified app 12 may generate a class call signal s1 when the segment of each class is executed and may generate a personal information call signal s2 when personal information is accessed (when a personal information access Application Programming Interface (API) is called) within the boundary of a specific class in response to a request for the personal information. The app-monitoring module 141 receives the class call signal s1 and the personal information call signal s2, which are generated by the modified app 12, when a service is provided by running the modified app 12.

The app pattern-recording module 142 stores the call signals s1 and s2 in a storage means, such as memory or like, and manages the signals. Also, according to the class call signal s1, the app pattern-recording module 142 analyzes the order in which classes are executed in the modified app 12, whether personal information is accessed, and the like. That is, the app pattern-recording module 142 records a user's app usage pattern, in which the class executed in the modified app 12, the personal information access API called therein, the personal information accessed (or requested) therein, and the like are classified for each service, in the storage means and updates the app usage pattern. Accordingly, the executed class, the called personal information access API, and the personal information accessed through the called API may be detected based on the user's app usage pattern.

The privacy level determination module 145 may apply a privacy level to each node that corresponds to each of the executed classes and calls of personal information access APIs according to the personal information call signal s2. Here, the privacy level may be determined by directly receiving predetermined information thereabout from a user, or may be determined through system recommendation information or information about a privacy policy preset by the user. The privacy level may be a level in which personal information is accessible by existing APIs or a level other than that. For example, the privacy level for address information may range in order, from a high level to a low level, for the sequence of a full address, a street, a city or state, and a country.

The personal information provision module 143 provides personal information corresponding to the determined privacy level by controlling the personal information extraction module 144 and the personal information modification module 146 according to the personal information call signal s2. The personal information extraction module 144 extracts personal information from the operating platform 20 under the control of the personal information provision module 143, and the personal information modification module 146 processes the extracted personal information in accordance with the determined privacy level.

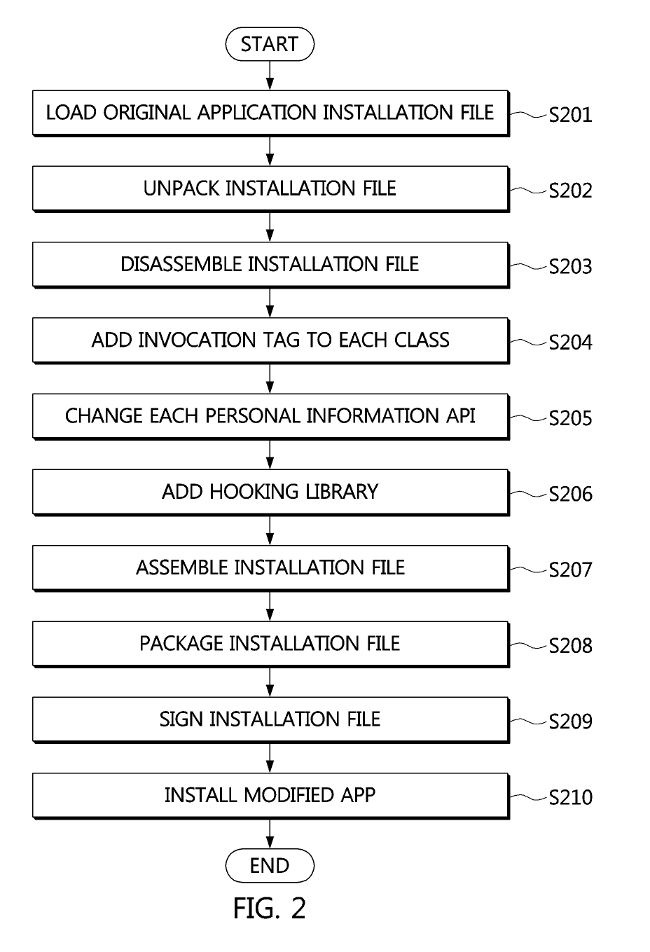

FIG. 2 is a flowchart for describing the operation of an application modification service of a privacy-protecting apparatus 100 according to an embodiment of the present invention.

Referring to FIG. 2, in order to modify the original app 10, the app parser module 121 of the app modification unit 120 loads the installation file (i.e., an Android Application Package (APK) file) of the original app 11 at step S201, unpacks the loaded file in order to release the compression thereof at step S202, and disassembles the binary code (i.e., smali file) of the unpacked file (for example, converts the file into a human-readable file) at step S203 in order to convert a file to an editable format.

The app modification module 122 adds code for an invocation tag in a function that is basically called whenever a corresponding class is executed (i.e. an OnCreate( ) function) in the disassembled code (file) at step S204 in order to identify the flow of execution of each class for providing a service (that is, in order to detect whether the corresponding class is executed). For example, the code for the invocation tag is added as shown in the underlined section in the following [Code 1]. The underlined section in [Code 1] corresponds to code in which the name of a corresponding class is set as a parameter and a class call signal s1 is sent to the personal information processing unit 140 when the corresponding class is executed.

.method public onCreate( )V
const-string v0, “public Lcom/ctri/JikiME”
invoke-static {v0}, Landroid1/init1;->init(Ljava/lang/String:)V
...
.end method

Next, in order to control a request for or access to the personal information managed in the operating platform 20, the app modification module 122 searches each class (code) for a personal information access API (code), which accesses personal information, and replaces the found personal information access API with an API configured so as to be controlled by the privacy-protecting apparatus 100 at step S205. For example, if the API that accesses position information corresponds to the following [Code 2], the code may be replaced with the API configured so as to be controlled by the privacy-protecting apparatus 100, as shown in [Code 3]. Accordingly, when a personal information access API is called within the boundary of the corresponding class, the personal information call signal s2 corresponding thereto may be generated.

[Code 2]

invoke-virtual {p1}, Landroid/location/Location; ->getLatitude( )D

[Code 3]

invoke-static { }, Landroid1/location/Location->getLatitude( )D

Next, the app modification module 122 adds a hooking library that serves to actually execute the modified code, which has been added or modified as described above, in a predetermined library at step S206.

The app installation module 123 converts the modified app 12 to an installable format by assembling and packaging the modified file of the original app 11 at steps S207 and S208, signs the file at step S209, and stores and installs the modified app 12 in the storage unit 10 at step S210.

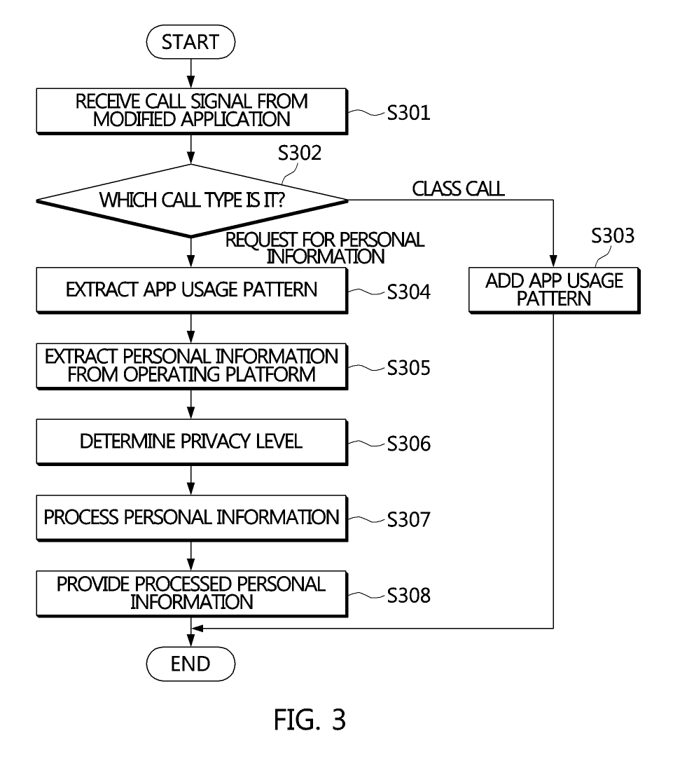

FIG. 3 is a flowchart for describing the operation for monitoring the execution of an application and providing personal information in a privacy-protecting apparatus 100 according to an embodiment of the present invention.

Referring to FIG. 3, if a service is provided by running the modified app 12, the modified app 12 may generate a class call signal s1 when executing a class, and may generate a personal information call signal s2 when personal information is accessed (when a personal information access API is called) within the boundary of a specific class in response to a request for the personal information. The app-monitoring module 141 receives the class call signal s1 and the personal information call signal s2 at step S301, which are generated by the modified app 12 when the service is provided by running the modified app 12.

Here, if the type of the call signal is a class call signal s1 at step S302, the app pattern-recording module 142 adds information about the call of the corresponding class executed in the modified app 12 in the user's app usage pattern at step S303.

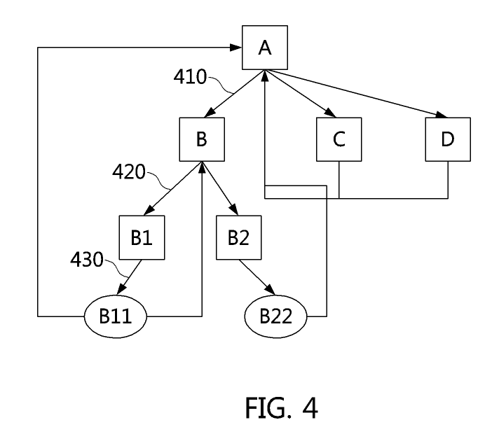

FIG. 4 is a view of an example of calling a class and personal information access API in a privacy-protecting apparatus 100 according to an embodiment of the present invention. In FIG. 4, the rectangles A, B, C, D, B1 and B2 represent calls of respective classes, the circles B11 and B22 represent calls of personal information access APIs, and the arrows represent available call paths. In the currently running modified app 12, the arrows 410, 420 and 430 represent the order in which classes and personal information access APIs are called when a user requests a service. The app pattern-recording module 142 may classify the executed classes, the called personal information access APIs, and the corresponding personal information for each service, record them in the user's app usage pattern, and update them. Accordingly, based on the user's app usage pattern, the executed class, the called personal information access API, and personal information accessed through the called personal information access API may be detected. According to need, the app pattern-recording module 142 may set the executed classes and personal information access API calls as nodes and set the sequences in which the classes are executed as edges, whereby the user's app usage pattern for each service may be displayed in a visual form, such as a graph or the like, on the screen of a user terminal, as shown in FIG. 4.

Also, if the type of the call signal is a personal information call signal s2 at step S302, the app pattern-recording module 142 extracts the user's app usage pattern at step S304 in order to separately record the executed class, the called personal information access API and the corresponding personal information.

According to the personal information call signal s2, the privacy-protecting apparatus 100 may specify a privacy level on the personal information to be provided to an application at the position 430 at which the personal information access API is called at the corresponding time, and may apply the privacy level when the personal information is provided.

First, the personal information extraction module 144 extracts personal information from the operating platform 20 at step S305 using the personal information access API under the control of the personal information provision module 143.

The privacy level determination module 145 may apply a different privacy level for the provision of personal information to each node in the above-described graph, which represents the app usage pattern of a user.

Here, the privacy level may be determined by directly receiving predetermined information about the privacy level from a user at the corresponding time, or may be determined through information about a privacy policy preset by a user or information recommended in the system (i.e., a server that operates in conjunction with an external server, or the like) at step 306. The privacy level may be a level in which personal information is accessible by existing APIs or a level other than that. When a user has previously used the service, the privacy level applied at the corresponding position is recorded, and the recorded privacy level may be reused. Also, in another example of the use of information recommended in the system, the privacy level of another user who has a similar app usage pattern may be recommended by the system, or the optimal privacy level may be recommended by an expert or in consideration of another context, but there is no limitation as to the method.

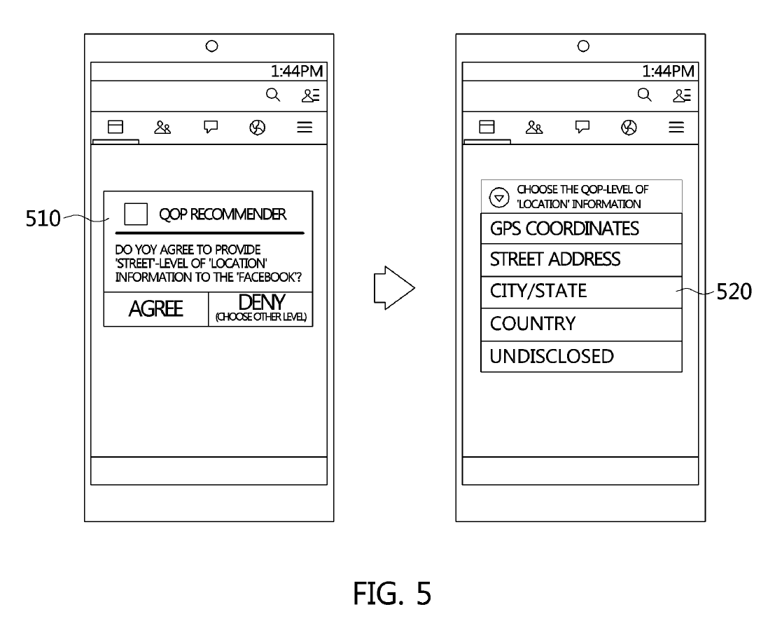

When information about a privacy level is input from a user, for example, the privacy level determination module 145 may display a screen for prompting a user to determine whether to agree with the provision of a “full address” in a user terminal, as shown in 510 of FIG. 5, and may receive the selection of a Quality of Protection (QoP) level from the user with regard to whether to agree with the provision of the address, as shown in 520 of FIG. 5. Accordingly, the privacy level, such as “street address->city/state->country”, “a location in a Global Positioning System (GPS)”, “undisclosed” and the like, may be determined.

When the privacy level is determined, the personal information modification module 146 processes the extracted personal information in accordance with the determined privacy level at step S307. The personal information provision module 143 provides the processed personal information to the currently running modified app 12.

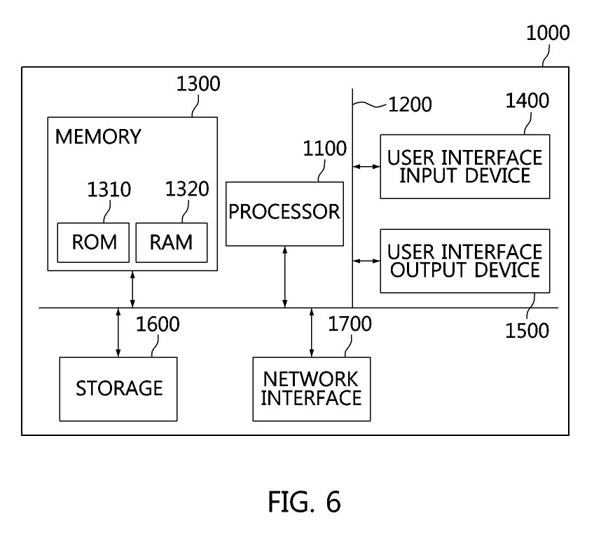

FIG. 6 is a view for describing an example of a method for implementing a privacy-protecting apparatus 100 according to an embodiment of the present invention.

The privacy-protecting apparatus 100 according to an embodiment of the present invention may be implemented as hardware, software or a combination thereof. For example, the privacy-protecting apparatus 100 may be implemented as the computing system 1000 shown in FIG. 6.

The computing system 1000 may include at least one processor 1100, memory 1300, a user interface input device 1400, a user interface output device 1500, storage 1600 and a network interface 1700, which are connected with each other via a bus 1200. The processor 110 may be a central processing unit (CPU) or a semiconductor device for processing instructions stored in the memory 1300 and/or the storage 1600. The memory 1300 and the storage 1600 may include various kinds of volatile or nonvolatile storage media. For example, the memory 1300 may include Read Only Memory (ROM) 1310 or Random Access Memory (RAM) 1320.

Accordingly, the step of performing the method or the step of executing the algorithm that has been described in connection with the embodiments disclosed in the present specification may be implemented as hardware, a software module or a combination thereof, which is executed by the processor 1100. The software module may be stored in the storage media, such as RAM, flash memory, ROM, EPROM, EEPROM, a register, a hard disk, a removable disk, or CD-ROM, that is, in the memory 1300 and/or the storage 1600. The exemplary storage media are coupled to the processor 1100, and the processor 1100 may read and interpret information stored in the storage media and write information thereto. In another example, the storage media may be integrated with the processor 1100. The processor integrated with the storage media may be stored in an Application-Specific Integrated Circuit (ASIC). The ASIC may be stored in a user terminal. In other examples, the processor and storage media may be stored in a user terminal as separate components.

As described above, in the privacy-protecting apparatus 100 according to the present invention, privacy levels are classified in detail depending on the usage pattern of an application used by a user in a user terminal in a mobile environment, and when the user determines a privacy level of personal information and status information stored in the user terminal, which are required when the user uses the application in a specific pattern, the personal information is processed depending on the corresponding purpose and the privacy level set thereon, and is then sent to the application. Accordingly, the privacy level of the personal information, required when a user is provided with a specific service, may be controlled, whereby the privacy may be protected and the utilization of the service may be improved.

Also, because an existing application is modified and the modified application informs a user of the executed class, the called personal information access API, and the personal information accessed through the called API when the user uses the service of the corresponding application, an app usage pattern is managed based on the informed information, whereby different levels may be set in order to appropriately provide personal information and the personal information is processed depending on the set level and sent to the application. Accordingly, the inconvenience whereby a privacy policy must be applied for each application may be solved, and a user may control the level related to the provision of personal information for each service of the application, whereby privacy may be protected.

Therefore, users may use the service of an application that has not been used due to concerns about their privacy, and the users may detect when or why their personal information is extracted and used in the applications that were used without regard to their privacy, whereby the users may acquire a desired level of services while protecting their privacy.

The above description merely illustrates the technical spirit of the present invention, and those skilled in the art may make various changes and modifications without departing from the scope of the present invention.

Accordingly, the embodiments, having been disclosed in the present invention, are intended not to limit but to describe the technical spirit of the present invention, and the scope of the technical spirit of the present invention is not limited to the embodiments. The scope of protection of the present invention must be interpreted based on the accompanying claims, and all the technical spirit in the same range as the claims must be interpreted as being included in the scope of rights of the present invention.

What is claimed is:

1. An apparatus for protecting privacy for controlling a level related to provision of personal information in response to a request for personal information in an application service provided in a user terminal, comprising:
an app modification unit for creating a modified app by modifying an original app in order to identify a flow of execution of a class for a service and to control processing of personal information; and
a personal information processing unit for updating a user's app usage pattern according to a class call signal received from the modified app, applying a privacy level to respective nodes for a class and a personal information access API, which are executed in the modified app, according to a personal information call signal received from the modified app, and providing the corresponding personal information to the modified app.

2. The apparatus of claim 1, wherein the app modification unit comprises an app modification module for modifying the original app in such a way that a tag is added in a function executed in each class so as to generate the class call signal when the corresponding class is executed in order to identify the flow of execution of the class, and in such a way that the personal information access API of each class is modified so as to generate the personal information call signal when the personal information is accessed.

3. The apparatus of claim 1, wherein the personal information processing unit comprises an app pattern-recording module for updating the user's app usage pattern in which the class executed in the modified app, the personal information access API called therein, and the corresponding personal information are classified for each service according to the class call signal.

4. The apparatus of claim 3, wherein the app pattern-recording module sets the executed class and a call of the personal information access API as nodes, sets a sequence in which classes are executed as an edge, and thereby provides the user's app usage pattern for each service in a graphical form on a screen of the user terminal.

5. The apparatus of claim 1, wherein the personal information processing unit comprises a privacy level determination module for determining a privacy level using information directly received from a user at a corresponding time, information about a preset privacy policy, and information recommended in a system in order to apply the privacy level to each of the nodes.

6. A method for protecting privacy for controlling a level related to provision of personal information in response to a request for personal information in an application service provided in a user terminal, comprising:
creating a modified app by modifying an original app in order to identify a flow of execution of a class for a service and to control processing of personal information; and
updating a user's app usage pattern according to a class call signal received from the modified app, applying a privacy level to respective nodes for a class and a personal information access API, which are executed in the modified app, according to a personal information call signal received from the modified app, and providing the corresponding personal information to the modified app.

7. The method of claim 6, wherein creating the modified app comprises modifying the original app in such a way that a tag is added in a function executed in each class so as to generate the class call signal when the corresponding class is executed in order to identify the flow of execution of the class, and in such a way that the personal information access API of each class is modified so as to generate the personal information call signal when the personal information is accessed.

8. The method of claim 6, wherein the user's app usage pattern is updated such that the class executed in the modified app, the personal information access API called therein, and the corresponding personal information are classified for each service.

9. The method of claim 8, further comprising:
setting the executed class and a call of the personal information access API as nodes, setting a sequence in which classes are executed as an edge, and thereby providing the user's app usage pattern for each service in a graphical form on a screen of the user terminal.

10. The method of claim 6, wherein providing the corresponding personal information to the modified app is configured such that the privacy level is applied to each of the nodes by determining the privacy level using information directly received from a user at a corresponding time, information about a preset privacy policy, and information recommended in a system.
